(19) United States
(12) Patent Application Publication
(10) Pub. No.: US 2012/0038652 A1
(43) Pub. Date: Feb. 16, 2012

(54) ACCEPTING MOTION-BASED CHARACTER INPUT ON MOBILE COMPUTING DEVICES

(75) Inventor: Yiching Yang, San Ramon, CA (US)

(73) Assignee: PALM, INC., Sunnyvale, CA (US)

(21) Appl. No.: 12/855,039

(22) Filed: Aug. 12, 2010

(51) Int. Cl. G06T 11/00

(52) U.S. Cl. 345/467

(57) ABSTRACT

A mechanism for accepting motion-based character input on a mobile computing device. In order to input a character, a user uses the mobile computing device like a pen to write the character in the air. The mechanism detects the movement of the mobile computing device (e.g., through an on-board accelerometer), recognizes a sequence of strokes the user is making using the mobile computing device, recognizes the character based on the sequence, and inputs the character on the mobile computing device (e.g., renders on a display).

### BACKGROUND

1. Field of Art

The disclosure generally relates to the field of user interface in computing devices.

2. Description of Art

As mobile computing technology advances, more and more applications become available for mobile computing devices. As a result, users use the mobile computing devices to perform more activities. These activities often involve inputting characters into the mobile computing devices. To facilitate such character input, a mobile computing device often provides a keyboard (physical or displayed) for its user to type in the characters. Keyboard input is convenient for alphabet-based languages such as English, French, and Russian. Non-alphabetic languages (i.e., languages not using an alphabet system, such as Chinese, Japanese, and Korean), due to the thousands of possible characters in these languages, cannot be easily typed in using the keyboard. Inputting characters in a non-alphabetic language typically requires special input methods (e.g., keyboard input method editors) which are complicated and require additional learning.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1a illustrates one example embodiment of a mobile computing device in a first positional state.

FIG. 1b illustrates one example embodiment of the mobile computing device in a second positional state.

FIG. 2 illustrates one example embodiment of an architecture of a mobile computing device.

FIG. 3 illustrates one example embodiment of an architecture of a motion input module.

FIGS. 4 and 5 collectively illustrate one example embodiment of a process of a motion input module.

FIGS. 6A through 6C are diagrams illustrating a Chinese character, an associated movement, and a corresponding mapping table entry according to one example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

One embodiment of a disclosed system (and method and non-transitory computer readable storage medium) accepts motion-based character input on the mobile computing device. In order to input a character on the mobile computing device using the motion-based character input, a user uses the mobile computing device to outline a character in a three-dimensional space. The system detects the movement of the mobile computing device (e.g., through an on-board accelerometer), recognizes a sequence of strokes the user is making using the mobile computing device, recognizes the character based on the sequence, and inputs the character on the mobile computing device (e.g., renders on a display).

### Example Mobile Computing Device

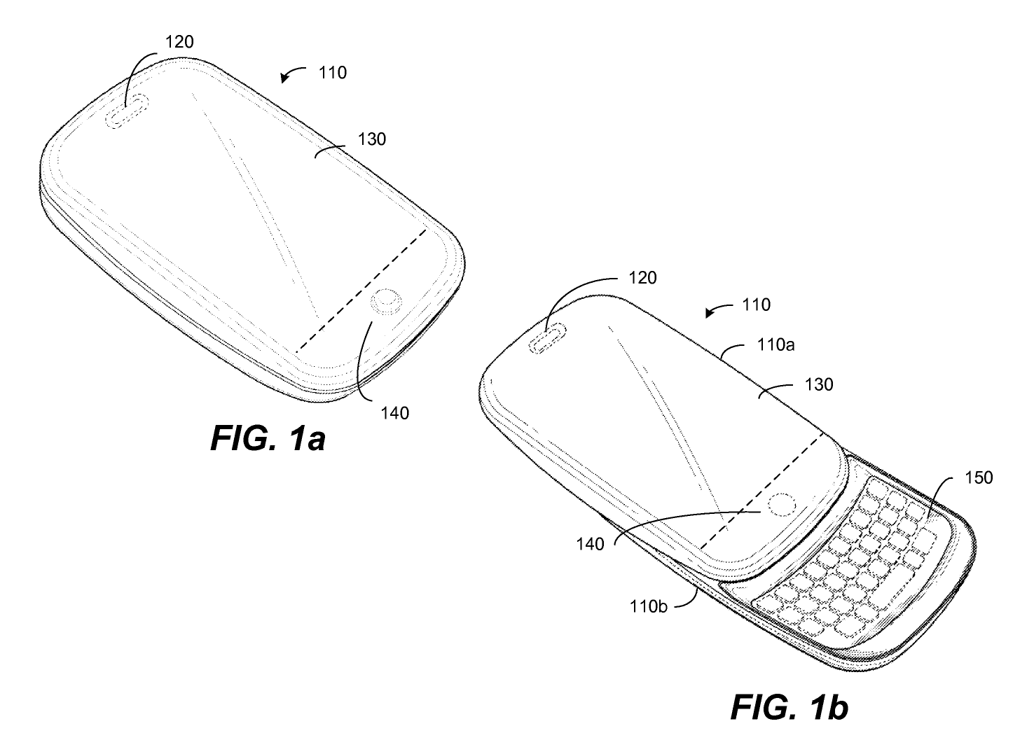

In one example embodiment, the configuration as disclosed may be configured for use between a mobile computing device, that may be host device, and an accessory device. FIGS. 1a and 1b illustrate one example embodiment of a mobile computing device 110. Figure (FIG.) 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., desktop computers, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. In one embodiment the screen may be 1.5 inches to 5.5 inches (or 4 centimeters to 14 centimeters) diagonally. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

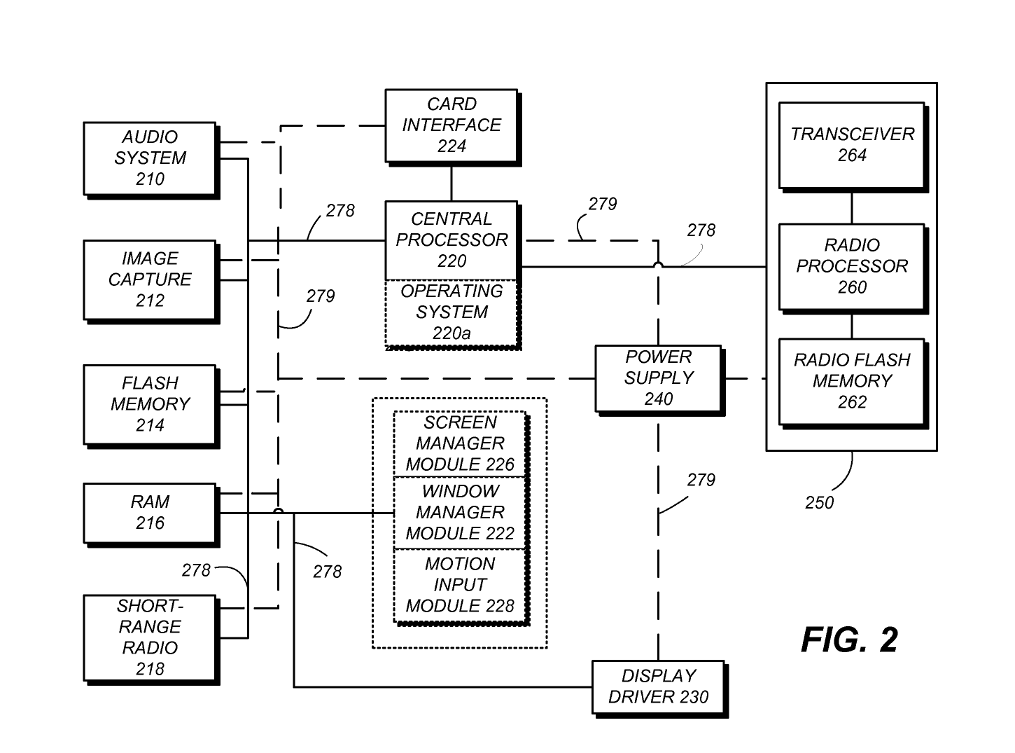

Referring next to FIG. 2, a block diagram illustrates components of an architecture of a mobile computing device 110 with telephonic functionality, according to one example embodiment. By way of example, the architecture illustrated in FIG. 2 will be described with respect to the mobile computing device of FIGS. 1a and 1b. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system 220a. The operating system 220a is an interface between hardware and an application, with which a user typically interfaces. The operating system 220a is responsible for the management and coordination of activities and the sharing of resources of the mobile computing device 110. The operating system 220a provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor 220 communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

It is noted that in one embodiment, central processor 220 executes logic (e.g., by way of programming, code, or instructions) corresponding to executing applications interfaced through, for example, the navigation area 140 or switches. It is noted that numerous other components and variations are possible to the hardware architecture of the computing device 200, thus an embodiment such as shown by FIG. 2 is just illustrative of one implementation for an embodiment.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

A motion input module 228 comprises software, hardware, and/or firmware configured to accept motion-based character input. The module 228 detects motions of the mobile computing device 110 though an on-board accelerometer (as further described below), and recognizes a sequence of strokes the user is making using the mobile computing device 110. The motion input module 228 compares the recognized sequence of strokes with a collection of stroke sequences each of which uniquely corresponds with a different character, identifies a character corresponding to the recognized sequence, and transmits the character as user input to a current application running on the mobile computing device 110.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120. The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) or fourth-generation (4G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

### Character Decomposition and Segment Sequence-Character Mapping Table

A character of an alphabetic-based language such as English, or of a non-alphabetic language such as Chinese, Japanese, and Korean, can be decomposed into a unique sequence of strokes. A stroke comprises a continuous portion of a character that typically is drawn when the character is written. A stroke can be straight, curved, and/or circular, and may include one or more twists and/or turns.

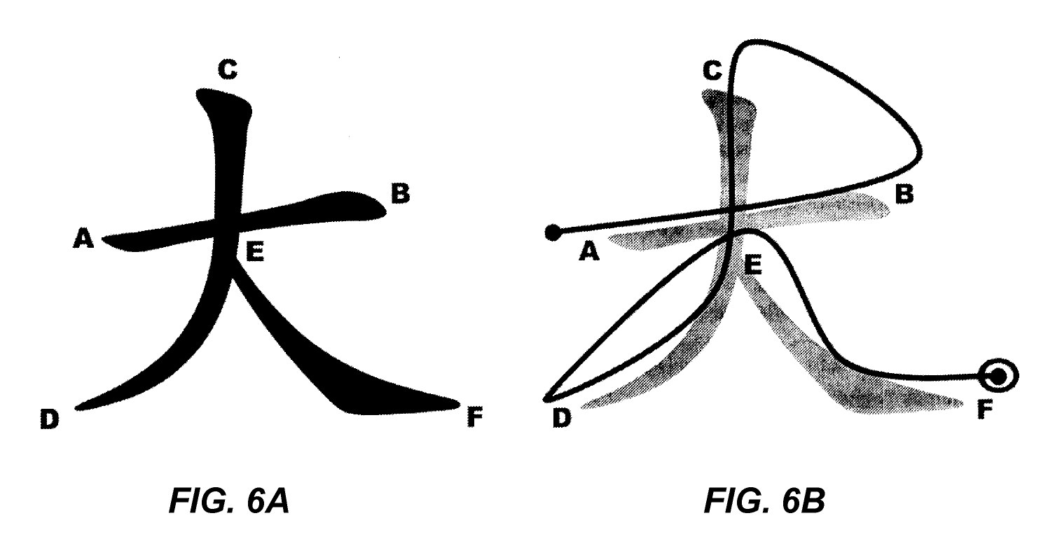

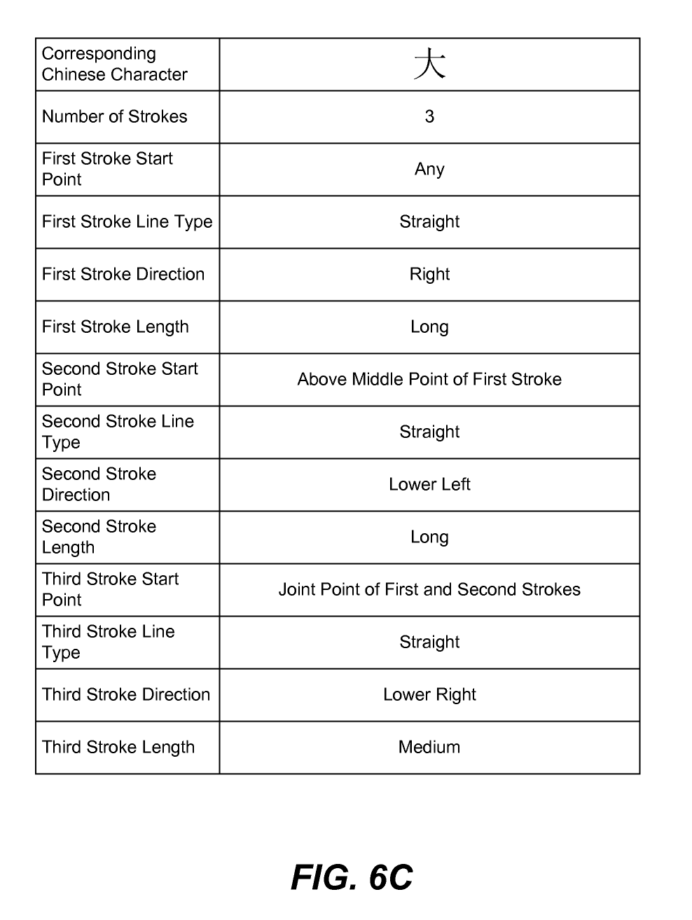

Using the Chinese language as an example, a Chinese character is drawn in a particular sequence. Further, each stroke is drawn in a particular way. For example, FIG. 6A shows a Chinese character “big” along with six labels A through F illustrating end points of three strokes that collectively form the character. As shown, the Chinese character “big” can be decomposed into three strokes: the first horizontal stroke AB, the second curved stroke CD, and the third stroke EF. The first stroke (AB) is always the first stroke to be drawn, and is always drawn from the left (point A) to the right (point B). The second stroke (CD) is always the second stroke to be drawn, and always starts above the first stroke (point C), crosses the first stroke near its middle point, and goes downward to the left (point D). The third stroke (EF) is always the last stroke to be drawn, and always starts where the first stroke and the second stroke meet (point E), and goes downward to the right (point F).

As shown above, the Chinese character “big” can be decomposed into a unique sequence of three strokes, each of which is characterized by attributes such as direction, position, and length relative to other strokes in the sequence. Similarly, other Chinese characters can be decomposed into a unique sequence of strokes. These stroke sequences and their corresponding Chinese characters can be stored in a segment sequence-character mapping table (also called a “mapping table”).

FIG. 6C illustrates an entry in a mapping table for the Chinese character “big” according to one embodiment. As shown, for each stroke of the character, the table entry includes the following information: the stroke start point, line type (e.g., straight, curve), direction, and length. It is noted that in alternate embodiments, the mapping table may include other information regarding how particular characters are defined for recognition, e.g., stroke stop point, directionality (e.g., loops, twists, turns (e.g., tildes, circles)), and/or velocity. Different mapping tables can be created to store the stroke sequences and corresponding characters of different languages. It is noted that a mapping table may include multiple different stroke sequences for a same character to accommodate different ways of writing the character.

### Example Architecture of Motion Input Module

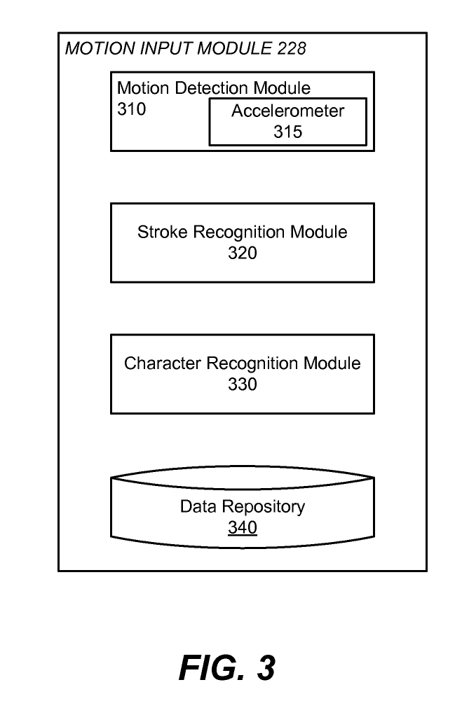

Referring now to FIG. 3, a block diagram illustrating example submodules within the motion input module 228 according to one example embodiment. Some embodiments of the module 228 have different and/or other submodules than the ones described herein. Similarly, the functions can be distributed among the submodules in accordance with other embodiments in a different manner than is described here. As illustrated, the motion input module 228 includes a motion detection module 310, a stroke recognition module 320, a character recognition module 330, and a data repository 340.

The motion detection module 310 is configured to detect movements of the mobile computing device 110. As shown, the motion detection module 310 includes an accelerometer 315 configured to measure device velocity (direction and speed), acceleration, and/or orientation (collectively called the movement measures) in a coordinate system such as a Cartesian coordinate system (a coordinate system for which the coordinates of a point are its distances from a set of perpendicular lines that intersect at the origin of the system). The motion detection module 310 (or the accelerometer 315) first locates a point in the coordinate system representing the starting point of the mobile computing device 110, and then measures the detected movements of the device with regard to the starting point in the coordinate system.

It is noted that in alternate embodiments, other motion detecting sensors may be used to detect motion along an x-plane, a y-plane and a z-plane in a three dimensional space. Further, sensors to track velocity may also be used, for example, to detect accents or highlights on special characters. The motion detection module 310 traces the device spatial positions of the mobile computing device 110 during the device movements based on the movement measures provided by the accelerometer 315, and provides the device positions and the movement measures to the stroke recognition module 320 in real time. The spatial movements are relative to an x-plane, a y-plane and/or a z-plane in a three-dimensional geometric space.

Examples of the spatial movements include linear movements (or straight movement), curved movements, and rotational movements. A linear/curved movement is a movement of the mobile computing device 110 along a straight/curved line in the three-dimensional geometric space. A rotational movement is a movement of the mobile computing device 110 that involves rotating the mobile computing device 110 around an axis in the three-dimensional geometric space. In the following description of spatial movements, reference is made to the mobile computing device 110 in which a “head” of the device is the end of the mobile computing device 110 near the speaker 120, and a “bottom” of the device is the opposite end near the navigation area 140. For example, an upward/downward tilting movement is an upward/downward rotational movement of the mobile computing device 100 approximately around the bottom of the device.

The stroke recognition module 320 is configured to recognize strokes drawn by the user using the mobile computing device 110 based on the real-time movement measures and device positions provided by the motion detection module 310. In one embodiment, the stroke recognition module 320 determines the beginning of a stroke based on the incurrence of a special device movement (called the “beginning gesture”), such as tilting the mobile computing device 110 downward (e.g., moving the head of the mobile computing device 110 downward while maintaining the bottom of the mobile computing device 110 relatively stable). Similarly, the stroke recognition module 320 determines the ending of a stroke based on the incurrence of another special device movement (called the “ending gesture”), such as tilting the mobile computing device 110 upward. Thus, the stroke recognition module 320 can recognize the beginning and the end of a stroke based on the orientation change of the mobile computing device 110. In one embodiment, the user can indicate that a complete character has been drawn by making a termination gesture, such as a double tap in the air using the mobile computing device 110. Accordingly, the stroke recognition module 320 can also recognize a complete sequence of strokes for a character (e.g., strokes recognized between two termination gestures) based on the incurrence of the termination gesture. Once a complete stroke sequence is recognized, the stroke recognition module 320 provides the stroke sequence to the character recognition module 330.

The character recognition module 330 is configured to recognize characters based on the stroke sequences recognized by the stroke recognition module 320. The character recognition module 330 compares a stroke sequence with stroke sequences in a mapping table of a particular language for similarity matches. When comparing two stroke sequences for similarity match, the character recognition module 330 considers factors such as stroke direction(s), stroke length, and stroke position(s). In one embodiment, the direction, length, and/or position of a specific stroke are defined with respect to other strokes in the same sequence. The character recognition module 330 generates a similarity score to quantify the similarity between two stroke sequences. If two sequences are similar then the similarity score is high and otherwise low. The character recognition module 330 selects the stroke sequence in the mapping table with the highest similarity score as the matching sequence, identifies the character associated with the matching sequence as the recognized character of the recognized stroke sequence, and inputs the recognized character into a current application running on the mobile computing device 110 as user input.

The data repository 340 stores data used by the motion input module 228. Examples of such data include the mapping tables, previously recognized characters and corresponding recognized stroke sequences, and/or device movements. The data repository 340 may be a relational database or any other type of database.

### Example Process of Motion Input Module

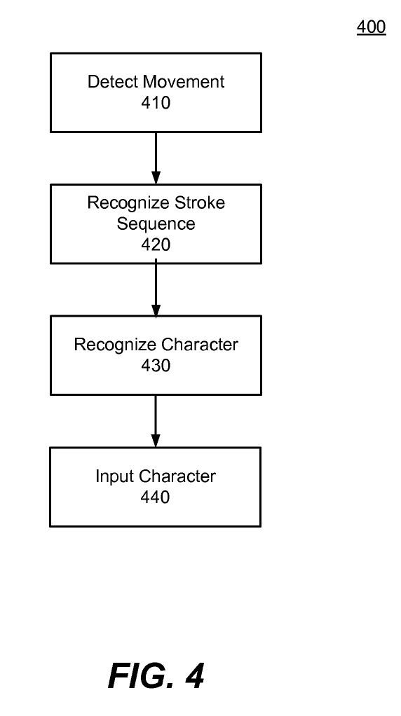

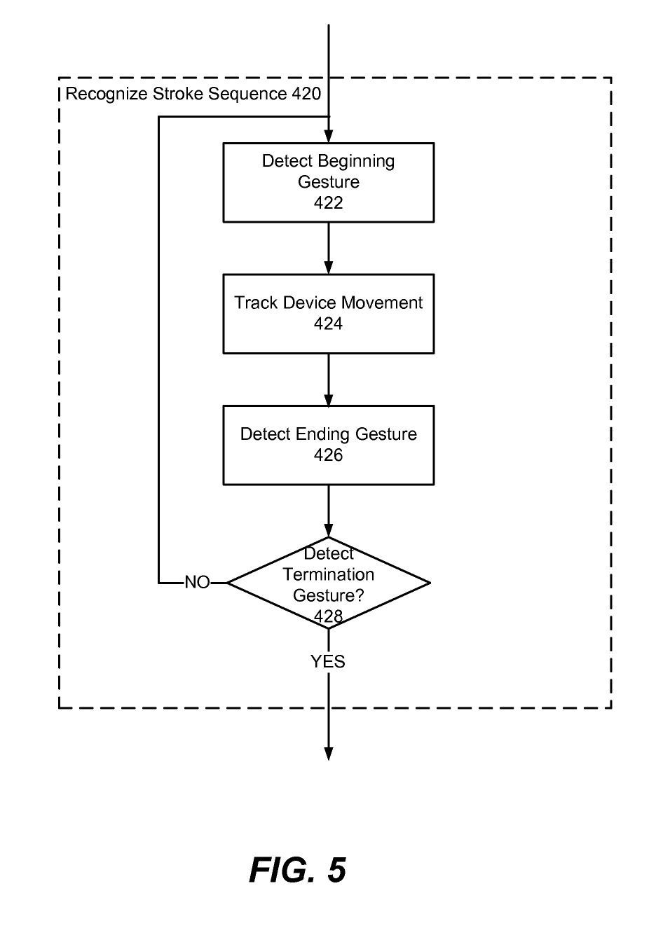

Referring now to FIGS. 4 and 5 including flowcharts that collectively illustrate a process 400 for the motion input module 228 to accept motion-based character input on the mobile computing device 110 according to one example embodiment. Other embodiments can perform the steps of the process 400 in different orders. Moreover, other embodiments can include different and/or additional steps than the ones described herein.

As shown, the motion input module 228 detects 410 device movements of the mobile computing device 110 based on the movement measures provided by the accelerometer 315, and recognizes 420 a sequence of strokes based on the detected device movements. Referring now to FIG. 5, a flowchart illustrating a process for the motion input module 228 to recognize the stroke sequence according to one embodiment. As shown, the motion input module 228 first detects 422 a beginning gesture (e.g., a downward tilting movement of the mobile computing device 110) that marks the beginning of a stroke, and tracks 424 the subsequent device movements/positions that collectively delineate the stroke until detecting 426 an ending gesture (e.g., an upward tilting movement of the mobile computing device 110). Once an ending gesture is detected 426, the motion input module 228 defines the gesture based on the path of the device in between the beginning gesture and the ending gesture relative to previously recognized strokes in the same sequence.

Once a stroke is recognized, the motion input module 228 determines 428 whether a termination gesture (e.g., a double tap) that marks the end of a character input is detected. If no termination gesture is detected 428, the motion input module 228 repeats the above process to recognize more strokes within the same sequence. If a termination gesture is detected, then the motion input module 228 moves on to the next step.

Referring back to FIG. 4, after recognizing a stroke sequence, the motion input module 228 recognizes 430 a character by comparing the stroke sequence with stroke sequences in a mapping table for similarity matches, and identifying the character associated with the stroke sequence having the highest similarity score as the recognized character. Once a character is recognized, the motion input module 228 inputs the character into a current application running on the mobile computing device 110 that accepts text input (e.g., a text messaging application) as user input. In one embodiment, instead of selecting and inputting the character with the highest similarity score, the motion input module 228 displays several characters with top similarity scores and prompts the user to select one as input.

### Additional Embodiments

In one embodiment, instead decomposing a character into a sequence of strokes, a character is represented by one single continuous movement that may include one or more twists and/or turns. Using the Chinese character “big” illustrated in FIG. 6A as an example, instead of decomposing the character into three strokes, the character can be represented by a continuous twist-and-turn movement that starts at point A and ends at point F, as illustrated in FIG. 6B.

In this embodiment, in order to input the Chinese character “big”, the user holds the mobile computing device 110 and starts drawing the first stroke (i.e., AB) by moving the mobile computing device 110 from the beginning of the stroke (point A) to the end of the stroke (point B) in the air like brushing on a wall. At the end of the first stroke, the user keeps moving the mobile computing device 110 to where the second stroke should start (point C) and then moves to the end of the second stroke (point D). At the end of the second stroke, the user keeps moving the mobile computing device 110 to where the third stroke should start (point E) and moves to the end of the third stroke (point F), and makes a termination gesture at or near the end of the third stroke (point F). The motion input module 228 recognizes the continuous twist-and-turn movement incurred before the termination gesture, and matches the recognized movement with a mapping table populated with characters and corresponding twist-and-turn movements for similarity matches. The motion input module 228 selects the character with the highest similarity score as the recognized character and inputs the recognized character into a current application running on the mobile computing device 110 as a user input.

Accordingly, the described configuration beneficially enables a user to input characters on a mobile computing device by holding the device like a pen and writing the characters in the air. As a result, users are no longer restricted to on-device keyboards (or keypads) and touch screens to input characters on mobile computing devices.

Some portions of above description describe the embodiments in terms of algorithms and symbolic representations of operations on information, for example, as illustrated and described with respect to FIGS. 4 and 5. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for accepting motion-based character input on a mobile computing device. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for accepting motion-based character input on a mobile computing device, comprising:
detecting a start of a spatial movement of the mobile computing device using an accelerometer on the mobile computing device;
responsive to detecting the start of the spatial movement, detecting within an Cartesian coordinate system a direction of the spatial movement incurred before a termination gesture and a path of the mobile computing device during the spatial movement using the accelerometer;
recognizing a character by matching the detected spatial movement with spatial movements representing characters for similarity; and
rendering the character on a display of the mobile computing device.

2. The method of claim 1, wherein recognizing the character comprises:
generating, for each of the spatial movements representing characters, a similarity score based on a similarity comparison between the spatial movement and the detected spatial movement; and
selecting a character represented by a spatial movement with a high similarity score as the recognized character.

3. The method of claim 2, wherein selecting the character comprises:
displaying for user selection a plurality of characters represented by spatial movements with high similarity scores;
receiving a user selection for one of the displayed characters; and
selecting the selected character as the recognized character.

4. The method of claim 1, further comprising:
recognizing a sequence of strokes based on the detected spatial movement, each stroke in the sequence is defined by a beginning gesture and an ending gesture and comprises a segment of the character,
wherein recognizing the character comprises recognizing the character by matching the sequence of strokes with stroke sequences representing characters for similarity.

5. The method of claim 4, wherein the beginning gesture comprises one of a downward tilting movement and an upward tilting movement, and the ending gesture comprises the other tilting movement.

6. The method of claim 4, wherein the stroke sequences representing characters comprises a plurality of stroke sequences representing a same character.

7. The method of claim 1, wherein matching the detected spatial movement with spatial movements representing characters for similarity comprises matching the detected spatial movement with spatial movements defined in a mapping table.

8. The method of claim 1, wherein the start of the spatial movement comprises a terminal gesture of a previous spatial movement, and wherein the termination gesture comprises a double tap.

9. The method of claim 1, wherein the character comprises one of the following: a character of a non-alphabetic language, and a character of an alphabet-based language.

10. A mobile computing device, comprising:
a non-transitory computer-readable storage medium storing executable computer program code for accepting motion-based character input, the computer program code comprising program code for:
detecting a start of a spatial movement of the mobile computing device using an accelerometer on the mobile computing device;
responsive to detecting the start of the spatial movement, detecting within an Cartesian coordinate system a direction of the spatial movement incurred before a termination gesture and a path of the mobile computing device during the spatial movement using the accelerometer;
recognizing a character by matching the detected spatial movement with spatial movements representing characters for similarity; and
rendering the character on a display of the mobile computing device.

11. The mobile computing device of claim 10, wherein recognizing the character comprises:
generating, for each of the spatial movements representing characters, a similarity score based on a similarity comparison between the spatial movement and the detected spatial movement; and
selecting a character represented by a spatial movement with a high similarity score as the recognized character.

12. The mobile computing device of claim 11, wherein selecting the character comprises:
displaying for user selection a plurality of characters represented by spatial movements with high similarity scores;
receiving a user selection for one of the displayed characters; and
selecting the selected character as the recognized character.

13. The mobile computing device of claim 10, further comprising:
recognizing a sequence of strokes based on the detected spatial movement, each stroke in the sequence is defined by a beginning gesture and an ending gesture and comprises a segment of the character,
wherein recognizing the character comprises recognizing the character by matching the sequence of strokes with stroke sequences representing characters for similarity.

14. The mobile computing device of claim 13, wherein the beginning gesture comprises one of a downward tilting movement and an upward tilting movement, and the ending gesture comprises the other tilting movement.

15. The mobile computing device of claim 13, wherein the stroke sequences representing characters comprises a plurality of stroke sequences representing a same character.

16. A non-transitory computer-readable storage medium encoded with executable computer program code for accepting motion-based character input on a mobile computing device, the computer program code comprising program code for:
detecting a start of a spatial movement of the mobile computing device using an accelerometer on the mobile computing device;
responsive to detecting the start of the spatial movement, detecting within an Cartesian coordinate system a direction of the spatial movement incurred before a termination gesture and a path of the mobile computing device during the spatial movement using the accelerometer;
recognizing a character by matching the detected spatial movement with spatial movements representing characters for similarity; and
rendering the character on a display of the mobile computing device.

17. The non-transitory computer-readable storage medium of claim 16, wherein recognizing the character comprises:
generating, for each of the spatial movements representing characters, a similarity score based on a similarity comparison between the spatial movement and the detected spatial movement; and
selecting a character represented by a spatial movement with a high similarity score as the recognized character.

18. The non-transitory computer-readable storage medium of claim 17, wherein selecting the character comprises:
displaying for user selection a plurality of characters represented by spatial movements with high similarity scores;
receiving a user selection for one of the displayed characters; and
selecting the selected character as the recognized character.

19. The non-transitory computer-readable storage medium of claim 16, wherein the computer program code further comprises program code for:
recognizing a sequence of strokes based on the detected spatial movement, each stroke in the sequence is defined by a beginning gesture and an ending gesture and comprises a segment of the character,
wherein recognizing the character comprises recognizing the character by matching the sequence of strokes with stroke sequences representing characters for similarity.

20. The non-transitory computer-readable storage medium of claim 19, wherein the beginning gesture comprises one of a downward tilting movement and an upward tilting movement, and the ending gesture comprises the other tilting movement.
